(19) United States
(12) Patent Application Publication
(10) Pub. No.: US 2023/0230361 A1
(43) Pub. Date: Jul. 20, 2023

(54) DOMAIN BATCH BALANCING FOR TRAINING A MACHINE LEARNING ALGORITHM WITH DATA FROM MULTIPLE DATASETS

(71) Applicant: GM Cruise Holdings LLC, San Francisco, CA (US)

(72) Inventors: Abdelrahman Elogeel, Sunnyvale, CA (US); Alexander Pon, San Francisco, CA (US); Debanjan Nandi, Fremont, CA (US); Andres Hasfura, San Antonio, TX (US); Carden Bagwell, San Francisco, CA (US); Marzieh Parandehgheibi, San Francisco, CA (US); Teng Liu, Jersey City, NJ (US); Brendan Fortuner, San Francisco, CA (US)

(21) Appl. No.: 17/580,251

(22) Filed: Jan. 20, 2022

(51) Int. Cl. G06V 10/774; G05D 1/00

(52) U.S. Cl. CPC G06V 10/7747; G05D 1/0088

(57) ABSTRACT

The subject disclosure relates to techniques for maintaining an optimized mix of samples selected from a smaller data set and a larger data set for use in training a machine learning algorithm. A process of the disclosed technology can include creating a plurality of chunks of samples, wherein each chunk contains a predetermined proportion of samples from the smaller data set and the larger data set, while also including substantially all samples in the larger dataset are distributed across the plurality of chunks of samples, loading a first chunk of samples of the plurality of chunks of samples into a memory, randomizing the order of samples in the first chunk of samples, and providing the samples in the first chunk of samples in the randomized order into the machine learning algorithm.

### BACKGROUND

### 1. Technical Field

The subject technology pertains to a data loader for maintaining an optimized mix of samples from multiple datasets for use in training a machine learning algorithm, and in particular, the subject technology pertains a data loader that samples from both real-world and simulation data sets for training a machine learning algorithm to detect objects in sensor data.

### 2. Introduction

Autonomous vehicles are vehicles that can leverage various machine learning models to operate safely and efficiently. These machine learning models require data to properly learn from. Obtaining real world data is limited by various factors including, but not limited to, time, cost, opportunities for autonomous vehicles to drive, etc. Due to these limiting factors, real world data may not be as common as needed. In other words, it may not be feasible to acquire enough real world data to adequately train some machine learning models.

### BRIEF DESCRIPTION OF THE DRAWINGS

FIG. 1 illustrates an example of a system for managing one or more Autonomous Vehicles (AVs) in accordance with some aspects of the present technology.

FIG. 2 illustrates an example lifecycle of a machine learning (ML) model in accordance with some aspects of the present technology.

FIG. 3 is a block diagram including an environment having a data loader in accordance with some aspects of the present technology.

FIG. 4 is a flowchart of a method for maintaining an optimized mix of samples selected in accordance with some aspects of the present technology.

FIG. 5 shows an example of a system for implementing certain aspects of the present technology.

### DETAILED DESCRIPTION

Autonomous vehicles are vehicles that can leverage various machine learning models to operate safely and efficiently. These machine learning models require data to properly learn from. Obtaining real world data is limited by various factors including, but not limited to, time, cost, opportunities for autonomous vehicles to drive, etc. Due to these limiting factors, real world data may not be as common as needed. In other words, it may not be feasible to acquire enough real world data to adequately train some machine learning model.

One solution to the lack of data can be leveraging simulated data that is based on the real world data. By simulating data based on real world data, an overall amount of data can be used to train these machine learning models. However, these simulated data sets may not result in an exact recreation of real world data as observed by sensors of an autonomous vehicle. In other words, it is difficult to leverage simulation data for training machine learning models to react in an expected manner in real world scenarios. Thus, there is still a need to also use real world data.

In other words, utilizing both real world data and simulated data can improve a total amount of data to train machine learning models without sacrificing understanding of the real world. However, this can also result in issues. For example, simulated data is much easier to generate and scale as compared to real world data. This can result in an imbalance of real world data and simulated data. For example, real world data can include 30,000 scenes observed by sensors of vehicles, while simulated data can be generated liberally and can include 300,000 scenes or more. In other words, simulated data can easily cause imbalances with potentially high ratios of simulated data to real world data. As a result, real world data sets can be exhausted much more quickly compared to the simulated data sets as the real world data sets and simulated data sets are fed into the machine learning models. Consequently, a tail end of the training of machine learning models would be directed towards the remaining data sets, which would be the simulated data sets. Thus, the resulting trained machine learning model can be biased towards simulated data and have comparatively lower performance of the real world. Accordingly, there is a need in the art for an efficient process of ensuring that machine learning models remain grounded in real world data.

The present technology provides solutions for these imbalance issues by proposing a novel data loader that samples from real and simulation data sets in a balanced way, such that the ratio between real and simulation samples is set to a pre-determined optimized value within a batch. This encourages the machine learning model to learn more general and informative features common to both real world and simulated data sets.

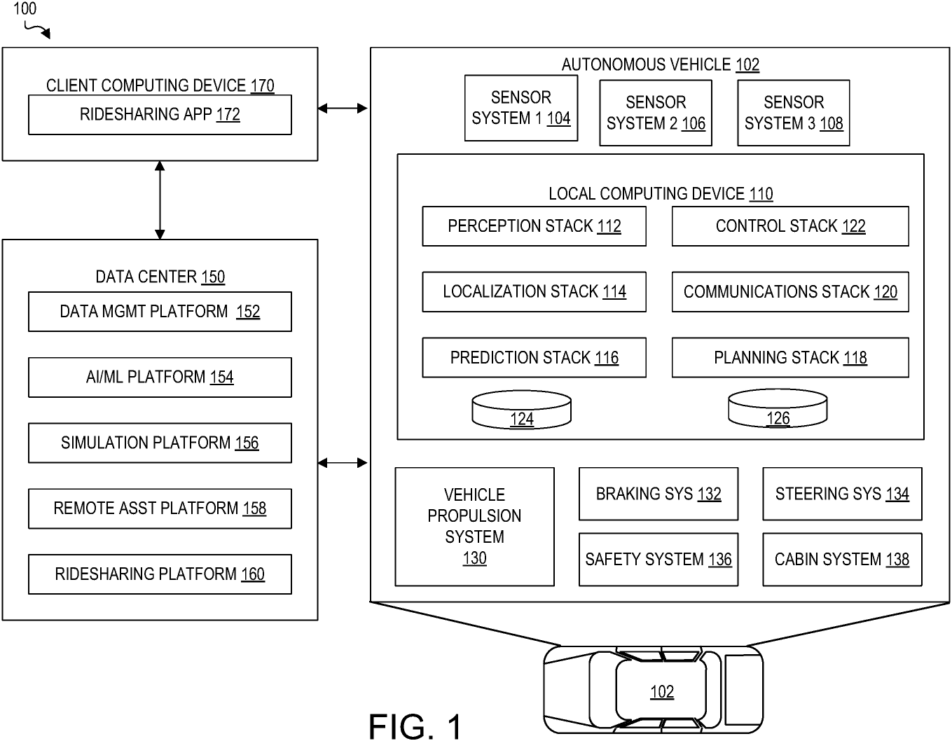

FIG. 1 illustrates an example of an autonomous vehicle (AV) management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., light detection and ranging (LIDAR) systems, ambient light sensors, infrared sensors, etc.), RADAR systems, global positioning system (GPS) receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUls), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV’s environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and a high definition (HD) geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV’s position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV’s steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user’s mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112 - 122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an laaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer’s mobile computing device or a computing device integrated with the AV 102 (e.g., the local computing device 110). The ridesharing platform 160 can receive requests to pick up or drop off from the ridesharing application 172 and dispatch the AV 102 for the trip.

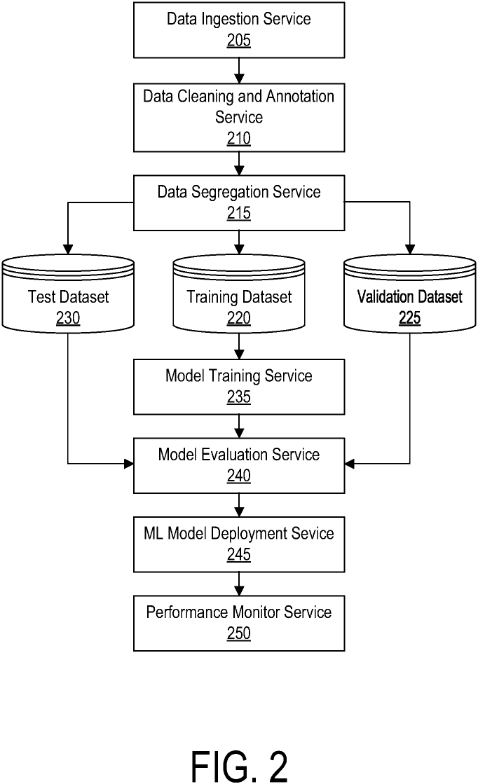

FIG. 2 illustrates an example lifecycle 200 of a ML model in accordance with some examples. Lifecycle 200 can be performed, for example, on AI/ML platform 154 as described above with respect to FIG. 1. The first stage of the lifecycle 200 of a ML model is a data ingestion service 205 to generate datasets described below. ML models require a significant amount of data for the various processes described in FIG. 2 and the data persisted without undertaking any transformation to have an immutable record of the original dataset. The data itself can be generated by sensors attached to an AV, for example, but can also be provided from third party sources such as publicly available dedicated datasets used for research purposes. The data ingestion service 205 provides a service that allows for efficient querying and end-to-end data lineage and traceability based on a dedicated pipeline for each dataset, data partitioning to take advantage of the multiple servers or cores, and spreading the data across multiple pipelines to reduce the overall time to reduce data retrieval functions.

In some cases, the data may be retrieved offline that decouples the producer of the data (e.g., an AV) from the consumer of the data (e.g., an ML model training pipeline). For offline data production, when source data is available from the producer (e.g., the AV), the producer publishes a message and the data ingestion service 205 retrieves the data. In some examples, the data ingestion service 205 may be online and the data is streamed from the producer (e.g., the AV) in real-time for storage in the data ingestion service 205.

After data ingestion service 205, a data preprocessing service preprocesses the data to prepare the data for use in the lifecycle 200 and includes at least data cleaning, data transformation, and data selection operations. The data preprocessing service 210 removes irrelevant data (data cleaning) and general preprocessing to transform the data into a usable form. In some examples, the data preprocessing service 210 may convert three-dimensional (3D) LIDAR data (e.g., 2D point cloud data) into voxels. The data preprocessing service 210 includes labelling of features relevant to the ML model such as people, vegetation, vehicles, and structural objects in the case of an AV. In some examples, the data preprocessing service 210 may be a semi-supervised process performed by a ML to clean and annotate data that is complemented with manual operations such as labeling of error scenarios, identification of untrained features, etc.

After the data preprocessing service 210, data segregation service 215 to separate data into at least a training dataset 220, a validation dataset 225, and a test dataset 230. Each of the training dataset 220, a validation dataset 225, and a test dataset 230 are distinct and do not include any common data to ensure that evaluation of the ML model is isolated from the training of the ML model.

The training dataset 220 is provided to a model training service 235 that uses a supervisor to perform the training, or the initial fitting of parameters (e.g., weights of connections between neurons in artificial neural networks) of the ML model. The model training service 235 trains the ML model based a gradient descent or stochastic gradient descent to fit the ML model based on an input vector (or scalar) and a corresponding output vector (or scalar).

After training, the ML model is evaluated at a model evaluation service 240 using data from the validation dataset 225 and different evaluators to tune the hyperparameters of the ML model. The predictive performance of the ML model is evaluated based on predictions on the validation dataset 225 and iteratively tunes the hyperparameters based on the different evaluators until a best fit for the ML model is identified. After the best fit is identified, the test dataset 230, or holdout data set, is used as a final check to perform an unbiased measurement on the performance of the final ML model by the model evaluation service 240. In some cases, the final dataset that is used for the final unbiased measurement can be referred to as the validation dataset and the dataset used for hyperparameter tuning can be referred to as the test dataset.

After the ML model has been evaluated by the model evaluation service 240, a ML model deployment service 245 can deploy the ML model into an application or a suitable device. The deployment can be into a further test environment such as a simulation environment, or into another controlled environment to further test the ML model. In the case of an AV, the ML model would need to undergo further evaluation inside a simulated environment and, after further validation, could be deployed in the AV. In some examples, the ML model could be implemented as part of the perception stack 112 to detect objects.

After deployment by the ML model deployment service 245, a performance monitor 250 monitors for performance of the ML model. In some cases, the performance monitor service 250 can also record performance data such as driving data that can be ingested via the data ingestion service 205 to provide further data, additional scenarios, and further enhance the training of ML models.

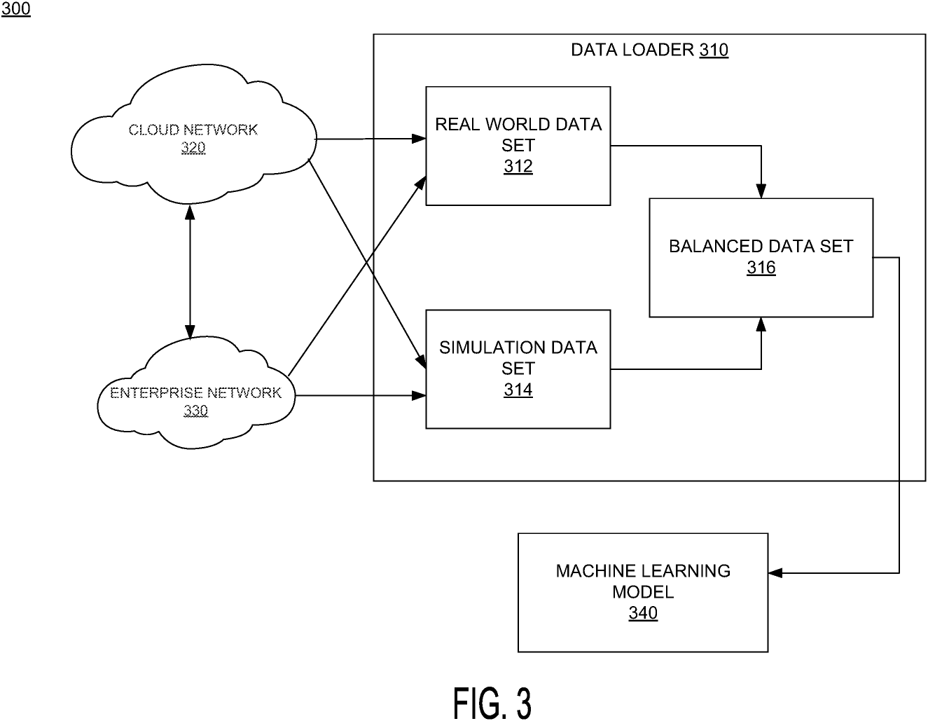

FIG. 3 is a block diagram including an environment 300 having a data loader 310 in communication with a cloud network 320, an enterprise network 330, and a machine learning model 340.

Data loader 310 is configured to utilize a real world data set 312 and a simulation data set 314 to generate a balanced data set 316. More specifically, data loader 310 can utilize a ratio or proportion of real world data set 312 and simulation data set to create balanced data set in accordance with the ratio. In some embodiments, the ratio may be a 1:1 correlation of real world data in real world data set 312 to simulated data in simulated data set 314. It is also to be understood that data loader 310 can request real world data set 312 and/or simulation data set 314 from cloud network 320 and/or enterprise network 330. For example, cloud network 320 and/or enterprise network 330 may store real world data set 312 and/or simulation data set 314. Data loader 310 can then communicate with cloud network 320 and/or enterprise network 330 to request and obtain real world data set 312 and/or simulation data set 314. Data loader 310 can then generate balanced data set 316. It is also considered that data loader 310 can request real world data set 312 and/or simulation data set 314 as individual scenes, chunks, and/or an entirety of the data set. In some embodiments, data loader 310 can be used additionally or alternatively as data ingestion service 205 as described above with respect to FIG. 2. It is also considered that data loader 310 may also be referred to as a custom data loader.

It is also considered that the ratio that data loader 310 balances real world data set 312 to simulation data set 314 can be pre-determined and/or adjusted. As real world data set 312 and simulation data set 314 grow over time, it is considered that an optimal ratio of real world data to simulation data may deviate from one to one. The ratio or proportion of samples from the smaller set and the larger data set ensures that the machine learning algorithm learns equally from both data sets and does not become biased.

In some scenarios, real world data set 312 may not include enough scenes to be used at a desired ratio with simulation data set 314. In these scenarios, data loader 310 may repeat some or all scenes in real world data set to meet the ratio. While simulation data set 314 can also utilize repeated simulated scenes, simulation data set 314 can also be augmented to include new or additional simulated scenes.

It is also considered that data loader 310 can organize balanced data set 316 in a sequence that spaces out the smaller data set between each chunk of the larger data set. In other words, balanced data set 316 would result in a disproportionate amount of the larger data set (e.g., simulation data set 314), while also being exposed to the smaller data set at a lower, but consistent frequency. This can avoid the resulting trained machine learning model from being overly biased to the larger data set without increasing a quantity or size of the smaller data set. Additionally, in some scenarios, oversampling or undersampling of one data set over the other data set(s) may be desirable. In other words, by distributing all or substantially all samples in the larger dataset across the plurality of chunks of samples, the resulting machine learning algorithm is ensured to have utilized all of the samples without overly biasing the machine learning algorithm. Furthermore, by randomizing the order of samples in the first chunk of samples, the machine learning algorithm is prevented from becoming biased by the sequence of samples.

While the following discussion uses real world data set 312 and simulation data set 314, it is intended to be understood that data loader 310 can be configured to utilize any two or more types of data. In other words, instead of real world data set 312 and simulation data 314, data loader 310 could be configured to balance curated data and non-curated data. For example, certain weather effects, such as fog or steam, can be difficult for LiDAR sensors to properly detect. Data loader 310 can generate balanced data set 316 based on a curated data set (e.g., real world and/or simulated data including fog or steam) and a non-curated data set (e.g., real world and/or simulated data that is not screened for fog or steam). As another example, data loader 310 can be configured to balance three or more different data sets focusing on different objects. More specifically, a first data set can be directed to bicyclists, a second data set can be directed to vehicles, and a third data set can be directed to pedestrians. Thus, it is an object of the present disclosure that data loader 310 is configured to intake a plurality of different data sets and generate a balanced data set incorporating all of the different data sets in a balanced fashion to avoid bias towards any one data set. In other words, data loader 310 is configured to optimize sampling of each data set (e.g., based on desired ratios or proportions).

Real world data set 312 is a data set of data that is obtained from sensors of one or more autonomous vehicles after the autonomous vehicles have driven in the real world. More specifically, as autonomous vehicles navigate along streets and highways, sensors of the autonomous vehicle are constantly collecting data and storing the data. This data is the real world data and can be utilized as at least a portion of real world data set 312. Additionally, data can be referred to as scenes, which are individual snapshots of what the sensors perceive. Thus, the collection of data is a series or sequence of scenes in chronological order, which include all of the perceived objects around the autonomous vehicle while the autonomous vehicle drives along roads. In some embodiments, this data can be processed to include semantic labels, bounding boxes, labeled point clouds, and other identifying information to improve a machine learning model’s understanding of the data.

Simulation data set 314 is a data set of simulated data having simulated scenes. Simulated scenes are similar to real world scenes in that they are individual snapshots of what a sensor would perceive. Simulated data can be generated or simulated based on similar objects and/or scenes as those from real world data. For example, simulated data can include a simulated scene that has various other vehicles on a road with a given weather condition (e.g., foggy, raining, etc.). It is also considered that simulated data can include simulated scenes that include more diverse scenarios than real world data. For example, in a geographical location that rarely has a certain weather condition, the simulated scenes can include the rare weather condition (e.g., snow in Los Angeles). As another example, a simulated scene can include less common objects that may not be commonplace in the real world data (e.g., bulldozers driving on a freeway). As yet another example, a simulated scene can be a real world scene augmented with additional objects and/or environmental feature or weather conditions.

Balanced data set 316 is the output of data loader 310. More specifically, balanced data set 316 is a data set that includes real world data set 312 and simulation data set 314. Balanced data set 316 can be a randomized data set of chunks of real world data set 312 and simulation data set 314.

In some embodiments, cloud network 320 stores copies of all samples from both the real world dataset 312 and simulation dataset 314. Data loader 310 can be aware of identifiers of each sample from both datasets. Data loader 310 can parse the collection of samples from the real world dataset 312 and the simulation dataset 314 into chunks that contain a ratio of simulation data and real world data. Thereby, data loader 310 can make request for chunks of samples at one time from cloud network 320. Making fewer calls to cloud network 320 for data is more efficient. Therefore, combining the datasets into chunks can allow for greater efficiency in making requests from cloud network.

After the chunks containing both simulation data and real world data have been downloaded, data loader 312 can created a balanced dataset 316 by randomly selected samples from the chunks to create a randomized order of the samples to be feed into the machine learning model 340.

In some embodiments, data loader can request chunks of real world data set 312 and chunks chunks of simulation data set 314.. Thereby, data loader 310 can make request for chunks of samples at one time from cloud network 320. Making fewer calls to cloud network 320 for data is more efficient. Therefore, combining the datasets into chunks can allow for greater efficiency in making requests from cloud network.

After the chunks containing either simulation data and real world data have been download, data loader 310 can then make random selections from the chunks of real world data 312 and chunks of simulation data 314 and combine them to result in a balanced dataset with a randomized order of samples to be feed into the machine learning model 340.

In some embodiments, these chunks or mini-batches of real world data set 312 and/or simulation data set 314 can be randomized internally (e.g., the scenes in each chunk or mini-batch is randomized) and/or overall (e.g., the batches are in random orders of real world data and simulation data). Balanced data set 316 can then be used by machine learning model 340. In some embodiments, balanced data set 316 can be used additionally to or alternatively as training dataset 220, validation dataset 225, and/or test dataset 230 as described above with respect to FIG. 2.

In practice, real world data set 312 tends to be a smaller data set compared to a larger data set of simulation data set 314. However, it is to be understood that either real world data set 312 or simulation data set 314 can be either the larger data set or the smaller data set.

Cloud network 320 is a cloud hosted infrastructure that can store data (e.g., real world data set 312 and simulation data set 314) and communicate with enterprise network 330 and/or data loader 310. Cloud network 320 can be configured to receive a request from enterprise network 330 and/or data loader 310, process the request, and fulfill the request. For example, data loader 310 may request a chunk of real world data set 312 and/or simulation data set 314 from cloud network 320. Cloud network 320 can then receive, process, and fulfill the request by sending or communication the requested chunk of real world data set 312 and/or simulation data set 314.

Enterprise network 330 is an enterprise owned infrastructure that can store data (e.g., real world data set 312 and simulation data set 314) and communicate with cloud network 320 and/or data loader 310. Enterprise network 330 can be configured to receive a request from data loader 310, process the request, and fulfill the request. For example, data loader 310 may request a chunk of real world data set 312 and/or simulation data set 314. Enterprise network 330 can then receive, process, and fulfill the request by sending or communicating the requested chunk of real world data set 312 and/or simulation data set 314. In some embodiments, enterprise network 330 can fulfill the request by requesting and receiving the chunk from cloud network 320 and sending the chunk to data loader 310. It is also considered that, in some embodiments, data loader 310 can be a part of and executed on enterprise network 330.

Machine learning model 340 is configured to receive balanced data set 316 and learn therefrom. For example, machine learning model 340 can be an output of model training service 235 as described above with respect to FIG. 2.

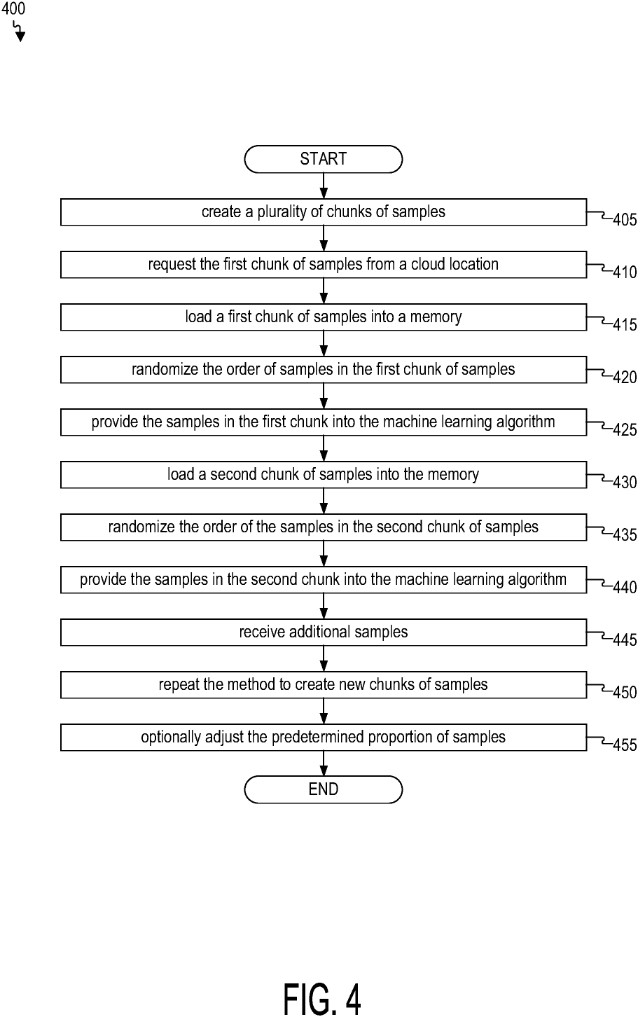

FIG. 4 illustrates an example method 400 for maintaining an optimized mix of samples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

In some embodiments, method 400 includes creating 405 a plurality of chunks of samples. For example, AI/ML platform 154 illustrated in FIG. 1 and/or data loader 310 illustrated in FIG. 3 may create 405 a plurality of chunks of samples. In some embodiments, the predetermined proportion is a 1:1 ratio of samples from the smaller data set and the larger data set. In some embodiments, each chunk contains a predetermined proportion of samples from the smaller data set and the larger data set, while also including substantially all samples in the larger dataset are distributed across the plurality of chunks of samples. In some embodiments, the smaller data set is a data set derived from real-world driving scenarios, and the larger data set is derived from simulated driving scenarios.

Creating 405 the plurality of chunks can include randomly selecting samples from both of the smaller data set and the larger data set consistent with the predetermined proportion. For example, AI/ML platform 154 illustrated in FIG. 1 and/or data loader 310 illustrated in FIG. 3 may randomly select samples from both of the smaller data set and the larger data set consistent with the predetermined proportion.

Creating 405 the plurality of chunks can also include marking selected samples with a selected flag to indicate them as selected to make them ineligible for re-selection. For example, AI/ML platform 154 illustrated in FIG. 1 and/or data loader 310 illustrated in FIG. 3 may mark selected samples with a selected flag to indicate them as selected to make them ineligible for re-selection.

Creating 405 the plurality of chunks can also include clearing the selected flag from the samples in the smaller data set after the samples have been exhausted, thereby allowing continued selection of sample from the larger data set to continue while maintaining the predetermined proportion. For example, AI/ML platform 154 illustrated in FIG. 1 and/or data loader 310 illustrated in FIG. 3 may clear the selected flag from the samples in the smaller data set after the samples have been exhausted, thereby allowing continued selection of sample from the larger data set to continue while maintaining the predetermined proportion.

In some embodiments, method 400 includes requesting 410 the first chunk of samples from a cloud storage location prior to loading the first chunk of samples into the memory. For example, AI/ML platform 154 illustrated in FIG. 1 and/or data loader 310 illustrated in FIG. 3 may request 410 the first chunk of samples from a cloud storage location prior to load the first chunk of samples into the memory. In some embodiments, requesting the first chunk of samples from the cloud storage location includes randomly determining a chunk of samples to request, whereby the chunks of samples are not selected in a predetermined order to prevent the machine learning algorithm from becoming biased by a sequence of chunks of samples. In some embodiments, requesting the first chunk of samples from the cloud storage location is performed by a custom data loader.

In some embodiments, method 400 includes loading 415 a first chunk of samples of the plurality of chunks of samples into a memory. For example, AI/ML platform 154 illustrated in FIG. 1 and/or data loader 310 illustrated in FIG. 3 may load 415 a first chunk of samples of the plurality of chunks of samples into a memory. In some embodiments, the steps of loading a first chunk of samples, loading a second chunk of samples, randomizing the order of the samples, and providing the samples to the machine learning algorithm are performed by a custom data loader.

In some embodiments, method 400 includes randomizing 420 the order of samples in the first chunk of samples. For example, AI/ML platform 154 illustrated in FIG. 1 and/or data loader 310 illustrated in FIG. 3 may randomize 420 the order of samples in the first chunk of samples.

In some embodiments, method 400 includes providing 425 the samples in the first chunk of samples in the randomized order into the machine learning algorithm. For example, AI/ML platform 154 illustrated in FIG. 1 and/or data loader 310 illustrated in FIG. 3 may provide 425 the samples in the first chunk of samples in the randomized order into the machine learning algorithm. In some embodiments, the machine learning algorithm is being trained to facilitate self-piloting of an autonomous vehicle.

In some embodiments, method 400 includes loading 430 a second chunk of samples into the memory. For example, AI/ML platform 154 illustrated in FIG. 1 and/or data loader 310 illustrated in FIG. 3 may load 430 a second chunk of samples into the memory.

In some embodiments, method 400 includes randomizing 435 the order of the samples in the second chunk of samples. For example, AI/ML platform 154 illustrated in FIG. 1 and/or data loader 310 illustrated in FIG. 3 may randomize the order of the samples in the second chunk of samples.

In some embodiments, method 400 includes providing 440 the samples in the second chunk of samples in the randomized order into the machine learning algorithm. For example, AI/ML platform 154 illustrated in FIG. 1 and/or data loader 310 illustrated in FIG. 3 may provide 440 the samples in the second chunk of samples in the randomized order into the machine learning algorithm.

In some embodiments, method 400 can repeat loading 430 another chunk of samples into the memory, randomizing 435 the order of the samples in the other chunk of samples, and providing 440 the samples of the other chunk of samples until all chunks of samples have been provided to the machine learning algorithm. In some embodiments steps 430, 435, and 440 can be repeated until the machine learning algorithm achieves a threshold accuracy value.

In some embodiments, method 400 includes receiving 445 additional samples into the one of the smaller data set and/or the larger dataset. For example, AI/ML platform 154 illustrated in FIG. 1 and/or data loader 310 illustrated in FIG. 3 may receive additional samples into the one of the smaller data set and/or the larger dataset.

In some embodiments, method 400 includes repeating 450 creating 405 a plurality of chunk of samples with the additional samples to create new chunks of samples at step 450. For example, AI/ML platform 154 illustrated in FIG. 1 and/or data loader 310 illustrated in FIG. 3 may repeat 450 creating 405 a plurality of chunks of samples with the additional samples to create new chunks of samples.

In some embodiments, method 400 includes optionally adjusting 455 the predetermined proportion of samples that come from the smaller dataset relative to the larger dataset. For example, AI/ML platform 154 illustrated in FIG. 1 and/or data loader 310 illustrated in FIG. 3 may optionally adjust 455 the predetermined proportion of samples.

While the present technology has been described with reference to a smaller dataset and a larger dataset as two different sources of training data, this is by way of example only. The two datasets can be any two different datasets that should be combined for training a machine learning model. In some embodiments, the smaller dataset is a dataset derived from real world samples, while the larger dataset is derived from simulation samples.

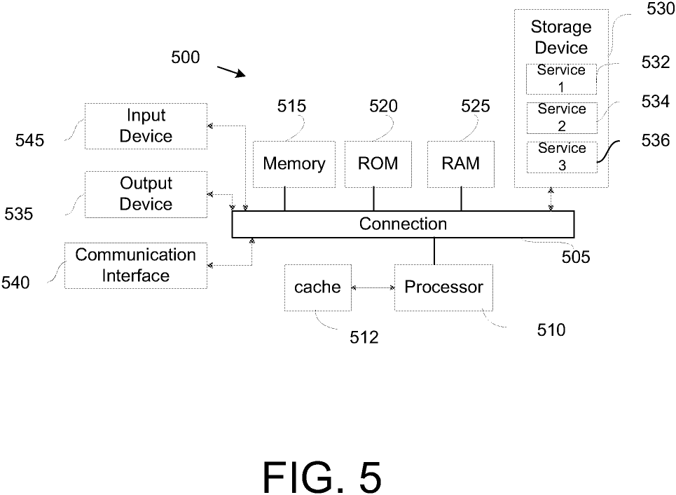

FIG. 5 shows an example of computing system 500, which can be for example any computing device making up autonomous vehicle 102, local computing device 110, data center 150, client computing device 170, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A method for maintaining an optimized mix of samples selected from a smaller data set and a larger data set for use in training a machine learning algorithm, the method comprising:
creating a plurality of chunks of samples, wherein each chunk contains a predetermined proportion of samples from the smaller data set and the larger data set, while also including substantially all samples in the larger data set are distributed across the plurality of chunks of samples;
loading a first chunk of samples of the plurality of chunks of samples into a memory;
randomizing an order of samples in the first chunk of samples; and
providing the samples in the first chunk of samples in the randomized order into the machine learning algorithm.

2. The method of claim 1, wherein the smaller data set is a data set derived from real-world driving scenarios, and the larger data set is derived from simulated driving scenarios.

3. The method of claim 1, wherein the machine learning algorithm is being trained to facilitate self-piloting of an autonomous vehicle.

4. The method of claim 1, further comprising:
requesting the first chunk of samples from a cloud storage location prior to loading the first chunk of samples into the memory.

5. The method of claim 4, wherein the requesting the first chunk of samples from the cloud storage location includes randomly determining a chunk of samples to request, whereby the chunks of samples are not selected in a predetermined order to prevent the machine learning algorithm from becoming biased by a sequence of chunks of samples.

6. The method of claim 4, wherein requesting the first chunk of samples from the cloud storage location is performed by a custom data loader.

7. The method of claim 1, wherein the predetermined proportion is a 1:1 ratio of samples from the smaller data set and the larger data set.

8. The method of claim 1, wherein the creating a plurality of chunks of samples further comprises:
randomly selecting samples from both of the smaller data set and the larger data set consistent with the predetermined proportion;
marking selected samples with a selected flag to indicate them as selected to make them ineligible for re-selection; and
clearing the selected flag from the samples in the smaller data set after the samples have been exhausted, thereby allowing continued selection of sample from the larger data set to continue while maintaining the predetermined proportion.

9. The method of claim 1, further comprising:
after providing the samples in the first chunk into the machine learning algorithm, loading a second chunk of samples into the memory;
randomizing an order of the samples in the second chunk of samples; and
providing the samples in the second chunk of samples in the randomized order into the machine learning algorithm.

10. The method of claim 9, wherein loading a first chunk of samples, loading the second chunk of samples, randomizing the order of the samples, and providing the samples to the machine learning algorithm are performed by a custom data loader.

11. The method of claim 9, further comprising:
repeating the method of claim 9 until all chunks of samples have been provided to the machine learning algorithm.

12. The method of claim 9, further comprising:
repeating the method of claim 9 until the machine learning algorithm achieves a threshold accuracy value.

13. The method of claim 1, further comprising:
receiving additional samples into the one of the smaller data set and/or the larger data set; and
repeating the method of claim 1 with the additional samples to create new chunks of samples.

14. The method of claim 13, further comprising:
adjusting the predetermined proportion of samples.

15. A system comprising:
a storage configured to store instructions; and
a processor configured to execute the instructions and cause the processor to:
create a plurality of chunks of samples, wherein each chunk contains a predetermined proportion of samples from a smaller data set and a larger data set, while also including substantially all samples in the larger data set are distributed across the plurality of chunks of samples,
load a first chunk of samples of the plurality of chunks of samples into a memory,
randomize an order of samples in the first chunk of samples, and
provide the samples in the first chunk of samples in the randomized order into a machine learning algorithm.

16. The system of claim 15, wherein the smaller data set is a data set derived from real-world driving scenarios, and the larger data set is derived from simulated driving scenarios.

17. The system of claim 15, wherein the machine learning algorithm is being trained to facilitate self-piloting of an autonomous vehicle.

18. The system of claim 15, wherein the processor is configured to execute the instructions and cause the processor to:
request the first chunk of samples from a cloud storage location prior to load the first chunk of samples into the memory.

19. The system of claim 18, wherein the requesting the first chunk of samples from the cloud storage location includes randomly determining a chunk of samples to request, whereby the chunks of samples are not selected in a predetermined order to prevent the machine learning algorithm from becoming biased by a sequence of chunks of samples.

20. A custom data loader embodied in instructions stored on a non-transitory computer-readable medium, the instructions effective to cause a computing device to:
request a random first chunk of samples from a cloud storage location, wherein the first chunk of samples is one of a plurality of chunks of samples stored at the cloud storage location, wherein each chunk contains a predetermined proportion of samples from a smaller data set and a larger data set, while also including substantially all samples in the larger data set distributed across the plurality of chunks of samples;
load the first chunk of samples of the plurality of chunks of samples received from the cloud storage into a memory;
randomize an order of samples in the first chunk of samples; and
provide the samples in the first chunk of samples in the randomized order into a machine learning algorithm.
